(19) United States
(12) Patent Application Publication
(10) Pub. No.: US 2024/0367672 A1
(43) Pub. Date: Nov. 7, 2024

(54) Method for Operating a Driver Assistance System for the Partially Automated Lateral Control of a Vehicle With Engagement of the Driver Upon Deactivation, Driver Assistance System, and Vehicle

(71) Applicant: Bayerische Motoren Werke Aktiengesellschaft, Muenchen (DE)

(72) Inventors: Christian STOCKINGER, Muenchen (DE); Joeran ZEISLER, Muenchen (DE)

(21) Appl. No.: 18/685,942

(22) PCT Filed: Aug. 26, 2022
(86) PCT No.: PCT/EP2022/073835

§ 371 Date: Feb. 23, 2024

(30) Foreign Application Priority Data
Aug. 27, 2021 (DE) 10 2021 122 259.1

(51) Int. Cl. B60W 50/14; B60W 30/18; B60W 60/00; G01C 21/36; G06V 20/56

(52) U.S. Cl. CPC B60W 50/14; B60W 30/18145; B60W 60/0053; G01C 21/3626; G06V 20/588; B60W 2540/223

(57) ABSTRACT

A method for operating a driver assistance system of a vehicle includes activating a driver assistance function of the driver assistance system, in which an at least partially automated lateral control of the vehicle is carried out; checking whether a driver has hands on the steering wheel of the vehicle; determining route course data which describe a future driving situation for the vehicle; estimating whether the future driving situation is a critical driving situation based on the route course data, which will lead to a deactivation of the activated driver assistance function; and issuing a takeover request to the driver for the manual lateral control of the vehicle in the event that the driver does not have hands on the steering wheel and that the future driving situation is a critical driving situation, the takeover request being issued before reaching the future critical driving situation.

### BACKGROUND AND SUMMARY

The present invention relates to a method for operating a driver assistance system of a vehicle. In addition, the present invention relates to a driver assistance system for a vehicle. Finally, the present invention relates to a vehicle having such a driver assistance system.

Driver assistance systems with which at least partially automated lateral control of the vehicle can be carried out are known from the prior art. Such driver assistance systems with partially automated lateral control assist the driver by taking over the task of steering. Unlike assistance systems for lane keeping, this assistance is not limited just to situational interventions, such as leaving a lane for example, but provides continuous lane-guidance assistance to the driver. During operation of the driver assistance system, lane markings and/or a driven trajectory of the vehicle ahead are usually acquired and used as a basis for the trajectory of the ego vehicle that is to be planned.

These driver assistance systems for partially automated lateral control to some extent allow the driver to temporarily take his/her hands off the steering wheel. This is also referred to as the tolerated hands-off state. In this case, however, the driver is reminded of the driving task after a relatively short time by way of visual and/or audible indications and requested to take over. Despite the high availability and the continuity strived for by the manufacturers, these driver assistance systems switch between an active state and a standby state. Such deactivation into the standby state is necessary, for example, when the upcoming driving situation cannot be sufficiently detected or sensed and the trajectory of the ego vehicle therefore cannot be planned. This is the case, for example, when the lane markings are completely missing or are only poorly visible. Another reason for this can be that trajectory planning or trajectory execution of the dynamic variables for such a system is not permissible. Corresponding limitations may result due to prevailing regulations or necessary restrictions from the point of view of safety of use or functional safety. This is the case, for example, when a radius of curvature is too tight. Provision is additionally made for the driver to be able to override such driver assistance functions at any time, or in this specific case to be able to take over the steering.

Upon the deactivation from the active state into the standby state, it is necessary for the driver, who currently does not have his/her hands on the steering wheel, to be requested to take over the vehicle. After this request, the driver has to once again put his/her hands on the steering wheel before he/she can manually influence the lane guidance. Such deactivations occur more often for particular road geometries; however, they are also dependent on external factors, such as, for example, sensibility in dependence on the environmental conditions and/or on the previous trajectory course of the ego vehicle. Before deactivation due to insufficient detection of the upcoming road traffic, the driver assistance system may cause steering movements that are implausible to the driver, which he/she would not have performed themselves. In these cases, the deactivation usually takes place only at the moment when the driver takes over control, at which moment the driver briefly works against the steering torque applied by the driver assistance system. Alternatively, the deactivation can take place only at the moment of the definitively necessary deactivation. This may occur if the vehicle leaves the lane after slowly leaving the lane for example during a cornering maneuver due to a prevailing maximum lateral acceleration limit.

The object of the present invention is to present a solution as to how a driver assistance system for the at least partially automated lateral control of a vehicle can be operated in a safer manner. In addition, a vehicle having such a driver assistance system is to be provided.

This object is achieved by a method, by a driver assistance system and by a vehicle having the features according to the claimed invention.

A method according to embodiments of the invention is used for operating a driver assistance system of a vehicle. The method comprises activating a driver assistance function of the driver assistance system, in which at least partially automated lateral control of the vehicle is carried out. In addition, the method comprises checking whether a driver of the vehicle has his/her hands on the steering wheel of the vehicle. Moreover, the method comprises determining route course data which describe a future driving situation for the vehicle. The method further comprises assessing, based on the route course data, whether the future driving situation is a critical driving situation which will lead to deactivation of the activated driver assistance function. Additionally, the method comprises outputting a takeover request to the driver for the manual lateral control of the vehicle if the driver does not have his/her hands on the steering wheel and if the future driving situation is a critical driving situation. In this case, the takeover request is output before the future critical driving situation is reached.

The driver assistance system can be used to carry out at least partially automated lateral control of the vehicle. Provision is preferably made for the driver assistance system to take over the lateral control of the vehicle completely. The driver assistance system can therefore assist the driver via steering activities in order to keep the vehicle in the lane. In order to identify the lane, an environmental sensor of the driver assistance system, in particular a camera, can be used to identify lane markings. Alternatively or in addition, the trajectory of at least one vehicle ahead can be acquired on the basis of measurements using an environmental sensor of the driver assistance system. The trajectory for this vehicle or for the ego vehicle can then be calculated on the basis of these data. Additionally, digital map data can be used and reactions to obstacles which restrict the lane of the ego vehicle can be performed.

During operation of the driver assistance system or while the driver assistance function is being carried out, the driver is allowed to take his/her hands off the steering wheel for a short time, for example for a duration of 30 seconds. The state when the driver is not touching the steering wheel or does not have his/her hands on the steering wheel is also referred to as the hands-off state. Additionally, it is checked whether the driver has his/her hands on the steering wheel. Using a corresponding sensor, for example a capacitive sensor on or in the steering wheel rim, it is possible to identify whether or not the driver is touching the steering wheel. An interior camera of the vehicle can also be used to identify whether or not the driver has his/her hands on the steering wheel. Furthermore, it is possible to check whether the driver is performing a steering movement on the steering wheel or whether the driver is applying a steering torque.

In addition, the route course data which describe at least one future driving situation for the vehicle are determined. In other words, the route course data in particular describe a driving situation which the vehicle will carry out in the future. For this purpose, the corresponding data which describe the future journey of the vehicle along a planned route or a likely route can be collected and then used as a basis for ascertaining the route course data. In addition, provision is made for it to be assessed, on the basis of the route course data or the future driving situation derived therefrom, whether the future driving situation is a critical driving situation. In the present case, a critical driving situation is in particular understood to be a driving situation which will lead to deactivation of the activated driver assistance function. It is thus possible to check whether the future driving situation is a critical driving situation with a high probability. Upon this deactivation of the driver assistance function, a transition from an active state into a standby state can take place. In the present case, the term “deactivation” is in particular not to be understood to mean that the driver assistance function is completely switched off or is transferred into an off state.

If the situation is identified whereby, firstly, the driver does not have his/her hands on the steering wheel and, secondly, the state is present where, on the basis of the assessment of the route course data, it is identified that the future driving situation is a critical driving situation, a takeover request is output to the driver. This takeover request prompts the driver to take over the manual lateral control of the vehicle again. In this case, this takeover request is output before the vehicle reaches the future critical driving situation. In a hands-off state, the driver is thus engaged in the driving task again before reaching a situation which will highly likely lead to deactivation.

In order to increase safety during the operation of the driver assistance system for the at least partially automated lateral control of the vehicle, the function should thus be enhanced by improved estimation of the particular operating area and/or the particular system limits. Optionally, these system limits should be comprehensibly displayed to the driver via early outputting of the takeover request. On the whole, the driver assistance system for the partially automated lateral control of the vehicle can therefore be operated in a safer manner.

As explained above, the driver assistance system can be used to carry out at least partially automated lateral control of the vehicle. Additionally, provision is preferably made for the driver assistance system to carry out at least partially automated longitudinal control of the vehicle. For example, the driver assistance system can be used to also provide adaptive cruise control (ACC) in addition to the lateral control.

In one embodiment, the future driving situation is a cornering and/or a turning maneuver and the assessment with regard to the deactivation is carried out during the cornering and/or during the turning maneuver in dependence on an expected functional quality of the driver assistance system. The term “functional quality” can in particular describe whether or not the driver assistance system is able to carry out the future driving task. The term “functional quality” can further describe how well the driver assistance system will carry out the future driving task.

The functional quality can be determined for example on the basis of the expected lateral acceleration. For this purpose, the speed of the vehicle during the future driving situation can be assessed. The speed of the vehicle during the future driving situation can be assessed on the basis of the current speed of the vehicle, on the basis of speed limits and/or on the basis of data of the partially automated longitudinal control.

Possible restrictive situations, such as excessively tight bends (including exits), turning maneuvers (including junctions), roundabouts, changes in the number of lanes (including lanes coming to an end, split or merged lanes) can thus be identified. In such restrictive situations, it is known in advance that they cannot be handled by the driver assistance system and that deactivation of the driver assistance function is therefore to be expected with a very high probability. Imminent deactivations due to known road geometries or elements that cannot be handled can thus take place before the critical point of the situation is reached. As a result, in addition to actually driving through the situation, the driver does not also have to correct the steering movements of the system that are possibly incorrect at system limits.

In addition, it is possible to evaluate bends which the vehicle will drive around in future. Here, for example, the expected lateral acceleration can be considered. If the expected lateral acceleration exceeds a predetermined threshold value, it can be assumed that the bend cannot be driven around using the activated driver assistance function. For this purpose, for example, the current speed, the radius of curvature or the like can be taken into account. Imminent deactivation due to known road geometries that cannot be handled thus takes place before the critical point of the situation is reached.

Here, it can furthermore be taken into account that the deactivation of the driver assistance function may take place due to an insufficient or failing solution during the calculation of the future trajectory. Moreover, the deactivation of the driver assistance function may take place due to a lack of feasibility. A lane coming to an end possibly requires a change of lane which the driver assistance system does not have to be able to carry out. A turning maneuver and/or a journey through a roundabout usually requires a high curvature which are limited for example due to steering limits, in particular the steering wheel rotation that is to be carried out, or changes in the curvature that is to be adjusted.

In a further embodiment, detection of a roadway is determined by an environmental sensor of the driver assistance system during the future driving situation on the basis of the route course data and the assessment with regard to the deactivation is carried out in dependence on the detection. It can thus be taken into account that the deactivation of the driver assistance function can occur due to a lack of detectability. It is thus possible to assess for the future driving situation whether the roadway can be detected in this region using at least one environmental sensor, in particular a camera of the driver assistance system. For example, it is possible to assess whether the roadway markings can be detected during the future driving situation. This can take place for example on the basis of information which describes whether roadway markings are present and/or are identifiable in the future route section. Additionally, use can be made of current weather conditions which are taken into account during the assessment of the detection. For example, in the case of snowfall, it can be assumed that the roadway markings cannot or cannot be sufficiently detected. Alternatively or in addition, for example, it is possible to check whether or not road users traveling ahead in the future driving situation can be detected for the purpose of planning the trajectory of the ego vehicle. In principle, it is thus possible to assess, on the basis of the route course data, whether trajectory planning for the ego vehicle is possible or with which probability this trajectory planning can be carried out.

In a further embodiment, sensor data from an environmental sensor of the driver assistance system are received and the route course data are determined on the basis of the sensor data. In this case, the environmental sensor can be in the form of a radar sensor, lidar sensor or the like. In particular, provision is made for the environmental sensor to be in the form of a camera and for the sensor data to be image data from the camera. On the basis of these image data, it is possible to detect an environmental region ahead of the vehicle in the direction of travel. These sensor data can be used for determining the route course data. The route course data can therefore in particular be determined on the basis of the current environment of the vehicle, in particular ahead of the vehicle in the direction of travel.

In a further embodiment, digital map data are received and the route course data are determined on the basis of the map data. Alternatively or in addition to the sensor data from the at least one environmental sensor, digital map data can thus be used for determining the route course data. These digital map data can describe route sections or elements in the road traffic which the vehicle will drive along in the future. Corresponding elements which cannot be driven through with active control of the lateral-controlling function can therefore be identified in a reliable manner. In this case, the source of correspondingly critical situations may be from the map data containing information about geometries or semantic elements which cannot be handled and cannot be driven through.

Furthermore, data from other road users, from infrastructure facilities, from a backend or the like can also be received. These data can be used to determine the route course data. For example, these data can describe elements in the road traffic, radii of curvature of bends, node points in the traffic or the like. The data can also describe the presence of roadway markings in certain route sections. The data can further describe the weather, precipitation on the roadway or the like. The route course data can thus be determined in a reliable manner.

Moreover, it is advantageous if deactivation data which describe deactivation of a driver assistance function of at least one other road user are received and the route course data are determined on the basis of the deactivation data. In other words, data which describe previous deactivations of the same or a similar driver assistance function in another vehicle can thus be collected. These deactivation data can thus describe that the driver assistance function in other vehicles has been deactivated in this driving situation. These data can for example be collected in a backend and subsequently transmitted to the vehicle. Alternatively or in addition, these data can be transmitted to the vehicle by way of vehicle-to-vehicle communication. In this way, corresponding situations can be learnt and taken into account in a vehicle-individual or fleet-based manner. Accumulation points of system-related deactivations that have been checked for plausibility can thus be taken into account.

As already explained, the driver can be prepared for the deactivation of the driver assistance function by way of a display/operator control concept. In this case, a so-called warning cascade can be provided. In this warning cascade, a display can initially be output in a particular color, for example in yellow. As a further warning level, a display in another color, for example red, can be output. In addition to this display, an audible signal can then be output. For example, a steering wheel symbol can be displayed in the different colors in the warning cascade. In this case, however, the temporal component of the warning cascade can be selected in minimal selection from allowed hands-off time and previous deactivations. Generally, the display/operator control concept can be provided by way of haptic feedback by way of steering wheel vibration, by way of simple visual warning messages via pictograms and/or by way of audible outputs.

Moreover, it is advantageous if information which describes a remaining distance and/or duration until the future critical driving situation is reached is output to the driver. In particular, this information can be output to the driver in addition to the takeover request. This information can in principle be output visually, audibly and/or haptically. In other words, provision can be made for a display/operator control concept which informs the driver about the expected deactivation of the driver assistance function ahead of time. For this purpose, provision is in particular made for this information to describe the remaining distance and/or the remaining time until the future critical driving situation is reached or until the deactivation is reached. Such information can be provided for example by a bar display—similar to a display of a navigation system. A corresponding display on the steering wheel or steering wheel rim can also be used to display the remaining time or distance. Provision can also be made for the previous deactivation behind a green steering wheel symbol, which is used to indicate the current active state, to be visualized with the time and/or distance information by the depiction of a gray steering wheel symbol, which is used to indicate the expected standby state.

A driver assistance system according to embodiments of the invention for a vehicle is set up to carry out a method according to embodiments of the invention and the advantageous configurations thereof. The driver assistance system can have at least one environmental sensor, in particular a camera, by way of which roadway markings in the environment of the vehicle can be detected. Alternatively or in addition, the environmental sensor or the camera can be used to identify vehicles traveling ahead. On the basis of the identified roadway markings and/or the detected road users traveling ahead, a trajectory for the vehicle can then be planned. Additionally, the driver assistance system is set up to take over lateral control of the vehicle and to therefore maneuver the vehicle along the planned trajectory in an at least partially automated manner. In particular, provision is additionally made for the driver assistance system to additionally carry out longitudinal control of the vehicle.

Additionally, the driver assistance system can have a corresponding sensor which can be used to check whether the driver has his/her hands on the steering wheel or on the steering wheel rim. A steering wheel sensor and/or an interior camera can be used for this purpose. Additionally, a steering wheel movement brought about by the driver can be detected for this purpose. Moreover, the driver assistance system can have an output device which can be used to output a takeover request to the driver. This output device can additionally be used to provide a display/operator control concept by way of which the driver is informed about the remaining duration and/or the remaining distance until reaching the future critical driving situation or the deactivation of the driver assistance system. Digital map data can additionally be stored in a memory of the driver assistance system. Furthermore, the driver assistance system can have a communication device for receiving map data and/or deactivation data which describe deactivations of driver assistance functions for other road users.

A vehicle according to embodiments of the invention comprises a driver assistance system according to embodiments of the invention. The vehicle is in particular in the form of a passenger car.

The method according to embodiments of the invention and the advantages thereof accordingly apply to the driver assistance system according to embodiments of the invention and to the vehicle according to embodiments of the invention.

Further features of the invention are evident from the claims, the figures and the description of the figures. The features and combinations of features mentioned above in the description, and the features and combinations of features mentioned below in the description of the figures and/or shown in the figures themselves, cannot only be used in the respectively specified combination but also in other combinations or by themselves without leaving the scope of the invention.

The invention will now be explained in more detail on the basis of preferred exemplary embodiments and with reference to the attached drawings.

### BRIEF DESCRIPTION OF THE DRAWINGS

FIG. 1 shows a schematic illustration of a vehicle which comprises a driver assistance system for the at least partially automated lateral control of the vehicle.

FIG. 2 shows the vehicle according to FIG. 1 before reaching a junction at which the driving situation to be carried out is a turning maneuver.

### DETAILED DESCRIPTION OF THE DRAWINGS

Identical or functionally identical elements are provided with the same reference signs in the figures.

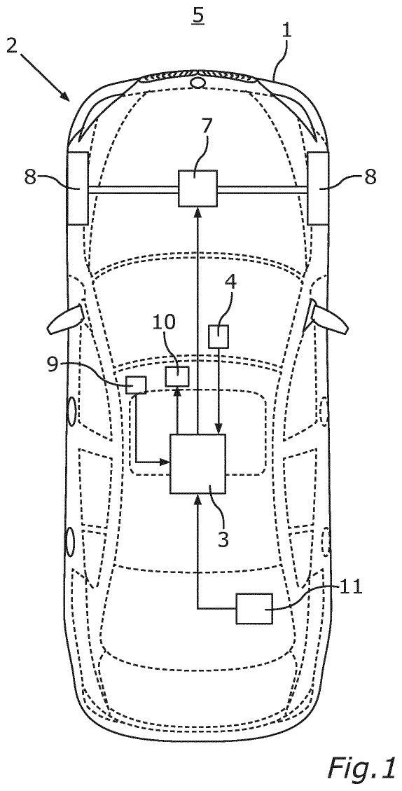

FIG. 1 shows a plan view of a vehicle 1 which in the present case is in the form of a passenger car. The vehicle 1 comprises a driver assistance system 2 which can be used to take over at least partially automated lateral control of the vehicle 1. The driver assistance system 2 comprises a computing device 3 which can be formed by at least one electronic control unit of the vehicle 1.

In addition, the driver assistance system 2 comprises an environmental sensor 4 which can in particular be in the form of a camera. The environmental sensor 4 can be used to detect an environmental region 5 ahead of the vehicle 1 in the direction of travel. In particular, the environmental sensor 4 can be used to detect roadway markings 6. Alternatively or in addition, the environmental sensor 4 can be used to detect road users traveling ahead. On the basis of the detected roadway markings 6 and/or the road users traveling ahead, the computing device 3 can then be used to calculate a trajectory for the vehicle 1, wherein the lateral control is carried out on the basis of the trajectory.

In addition, the computing device 3 is set up to actuate a steering system 7 (illustrated only schematically in the present case) of the vehicle 1. The actuation of the steering system 7 makes it possible for the lateral control of the vehicle 1 to be taken over during the activation of the driver assistance system 2. The actuation of the steering system 7 makes it possible for steerable wheels 8 of the vehicle 1 to be steered. The driver assistance system 2 can therefore be used to provide a driver assistance function. Provision is preferably additionally made for the computing device 3 to additionally be used to actuate a drive motor and/or a brake system of the vehicle 1 in order to take over longitudinal control of the vehicle 1.

In addition, the driver assistance system 2 comprises a steering wheel sensor 9 which can be used to detect whether the driver is touching the steering wheel (not illustrated here) of the vehicle 1. On the basis of the data from the steering wheel sensor 9, it is therefore possible to check during operation of the driver assistance system 2 or during the activated lateral control whether or not the driver has his/her hands on the steering wheel.

In addition, the driver assistance system 2 comprises an output device 10 which can be used to output visual, audible and/or haptic outputs to the driver. Finally, the driver assistance system 2 comprises a communication device 11 which can be used to receive digital map data. The digital map data can alternatively be stored in a memory of the driver assistance system. Additionally, the communication device can be used to receive data from other road users. These data or else deactivation data can in particular describe deactivations of the same or similar driver assistance systems for other road users.

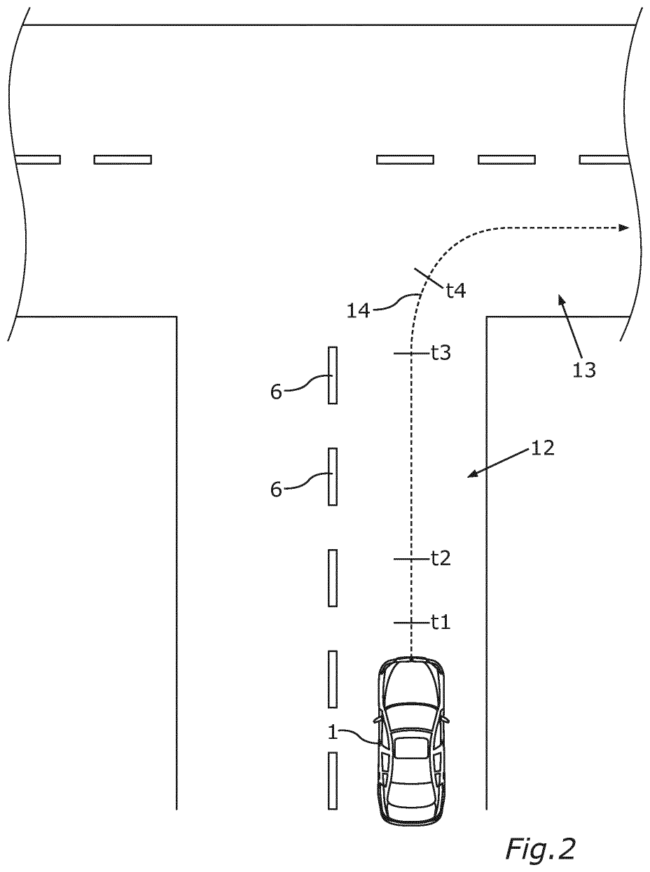

FIG. 2 shows the vehicle 1 according to FIG. 1 in an exemplary traffic situation. In the present case, it is assumed that the driver assistance system 2 is activated and the driver assistance system 2 is therefore being used to carry out partially automated lateral control of the vehicle 1. In the present case, the driver assistance system 2 maneuvers the vehicle 1 within a lane 12 on the basis of the detected roadway markings 6. Additionally, it is assumed that the driver currently does not have his/her hands on the steering wheel.

The computing device 3 is used to determine route course data which describe a future driving situation for the vehicle 1. These route course data can be ascertained on the basis of the sensor data from the environmental sensor 4, the digital map data and/or the data from the other road users. In the present case, the future driving situation is a turning maneuver during which the vehicle 1 turns to the right from the lane 12 into a lane 13. In this case, the line 14 describes an ideal path of the vehicle 1 during the future driving situation or during the turning maneuver. On the basis of this future driving situation or on the basis of the route course data, it is then possible to assess that this driving situation, e.g. due to an excessive lateral acceleration, will lead to deactivation of the driver assistance function of the driver assistance system 2. The future driving situation is therefore deemed to be a critical driving situation.

Provision is made for the driver of the vehicle 1 to be informed about the deactivation considerably before the critical driving situation is reached or before the driver assistance function is deactivated. In the present case, provision is therefore made for the output device 10 to output to the driver at a first time t1 information which describes a remaining duration and/or a remaining distance until the deactivation of the driver assistance system 2 is reached. In the present case, it is assumed that the driver assistance function is deactivated at the latest at a time t4 due to the tight radius of curvature for the turning maneuver. In the present case, however, provision is made for an earlier time t3 or the associated position to be displayed to the driver by way of the display/operator control concept for safety reasons. Additionally, at a time t2, the driver is requested to take over the steering or the lateral control. On the whole, safety can therefore be improved during the operation of the driver assistance system 2 for the at least partially automated lateral control of the vehicle 1.

1.-9. (canceled)

10. A method for operating a driver assistance system of a vehicle, the method comprising:
activating a driver assistance function of the driver assistance system in which at least partially automated lateral control of the vehicle is carried out,
checking whether a driver of the vehicle has hands on a steering wheel of the vehicle,
determining route course data which describe a future driving situation for the vehicle,
assessing, based on the route course data, whether the future driving situation is a critical driving situation which will lead to deactivation of the activated driver assistance function, and
outputting a takeover request to the driver for manual lateral control of the vehicle upon determining that the driver does not have the hands on the steering wheel and that the future driving situation is the critical driving situation, wherein the takeover request is output before the future critical driving situation is reached.

11. The method according to claim 10, wherein:
the future driving situation is a cornering and/or a turning maneuver and an assessment with regard to the deactivation is carried out during the cornering and/or during the turning maneuver in dependence on an expected functional quality of the driver assistance system.

12. The method according to claim 11, wherein:
detection of a roadway is determined by an environmental sensor of the driver assistance system during the future driving situation based on the route course data and the assessment with regard to the deactivation is carried out in dependence on the detection.

13. The method according to claim 10, wherein:
sensor data from an environmental sensor of the driver assistance system are received and the route course data are determined based on the sensor data.

14. The method according to claim 10, wherein:
digital map data are received and the route course data are determined based on the map data.

15. The method according to claim 10, wherein:
deactivation data which describe deactivation of a driver assistance function of at least one other road user are received and the route course data are determined based on the deactivation data.

16. The method according to claim 10, wherein:
information which describes a remaining distance and/or a remaining duration until the future critical driving situation is reached is output to the driver.

17. The driver assistance system for the vehicle, wherein the driver assistance system is configured to carry out the method according to claim 10.

18. The vehicle comprising the driver assistance system according to claim 17.

19. The vehicle according to claim 18, wherein the vehicle is a passenger car.
